(19) United States
(12) Patent Application Publication
(10) Pub. No.: US 2005/0165740 A1
(43) Pub. Date: Jul. 28, 2005

(54) System and method for scrolling within a list of documents

(76) Inventors: Bernard J. Kerr, Boston, MA (US); Daniel M. Gruen, Newton, MA (US); Steven L. Rohall, Winchester, MA (US); Paul B. Moody, Hyde Park, VT (US); Latoya Sankey, Everett, MA (US)

Correspondence Address: PILLSBURY WINTHROP SHAW PITTMAN, LLP, P.O. BOX 10500, MCLEAN, VA, 22102, US

(21) Appl. No.: 10/745,673

(22) Filed: Dec. 29, 2003

(51) Int. Cl. G06F 7/00

(52) U.S. Cl. 707/3

(57) ABSTRACT

A system and method are provided such that a user has the ability to more easily scroll to documents of a particular date. In one embodiment of the invention, a processing module of an email system utilizes a calendar view to scroll email messages listed in an inbox view to a particular date. A “Scroll Inbox View to Date” command allows a user to scroll the message set of the inbox view to email messages corresponding to the particular date.

### CROSS-REFERENCE TO RELATED APPLICATIONS

This application is related to the commonly owned co-pending U.S. patent application entitled “Method and Apparatus for Managing Documents with Dates and Times,” Attorney Docket No. 23452-523, filed herewith and incorporated by reference in its entirety.

### FIELD OF THE INVENTION

The invention relates to a user interface that scrolls to documents having a particular date.

### BACKGROUND OF THE INVENTION

Conventional calendar systems include documents (i.e. calendar events) associated with a date and/or time. In addition, some calendar systems include a date control that allows a user to view any documents associated with a particular date and/or time.

Further, other kinds of documents (i.e. non-calendar events), including email messages, are frequently associated with a date and time. Some users tend to recall such documents by their associated date and time, rather than by name, subject, location, or other information that characterizes the document. Accordingly, document lists that present an index of the documents typically include the ability to sort the index by date and time. For example, conventional email systems allow users to sort emails in ascending or descending order by date and time associated with the email. However, the user must normally scroll through these sorted documents in order to view or otherwise access documents associated with a particular date and/or time.

When the list of selected documents is lengthy, manually scrolling the list is time-consuming and frustrating.

What is needed is an improved scrolling mechanism for accessing documents associated with a particular date. It is an aspect of the invention to provide a user the ability to more easily scroll to documents of a particular date.

### SUMMARY OF THE INVENTION

The invention includes a user interface that provides a user with the ability to scroll to documents of a particular date. In some embodiments of the invention a calendar view of a file or email system allows a user to select a date and issue a command to scroll to documents or messages in another view, such as an index having the selected date.

In some embodiments of the invention, an email system utilizes a calendar view to scroll to email messages listed in an inbox view to a particular date. The calendar view includes an on-screen calendar showing the days of a particular month. When the user selects a particular date, the user may select a command such as “Scroll Inbox View to Date.” The scroll command causes a user the message set of the inbox view to scroll to email messages having a particular date.

In some embodiments of the invention, when the user chooses the scroll command the particular date may be transformed to a canonically formatted date. Then if the messages of the inbox view are not already sorted according to date and time, a sort command may be issued.

Once messages of the inbox view are sorted according to date and time, a “Find” command (or its equivalent) may be issued using a canonically formatted date as search terms. Messages with date and time that correspond to the particular date are returned.

If there are messages with date and time information that correspond to the particular date, the message set is scrolled such that the first message with the particular date is displayed. If there are no messages having the particular date and time an indication, such as, “No Match Found” may be provided to the user.

Other objects and features of the invention will become apparent from the following detailed description considered in connection with the accompanying drawings. The drawings are designed for purposes of illustration only and the invention is not limited to the particulars shown therein. Various alternatives and modifications within the scope of the invention will be apparent from the description contained herein.

### BRIEF DESCRIPTION OF THE DRAWINGS

FIG. 1 illustrates a system useful for scrolling to documents having a particular date, according to various embodiments of the invention.

FIG. 2 illustrates an inbox view and a calendar view of an email system, according to various embodiments of the invention.

FIG. 3 illustrates a process performed in accordance with one embodiment of the invention when a user selects a scroll command.

### DETAILED DESCRIPTION OF PREFERRED EMBODIMENTS

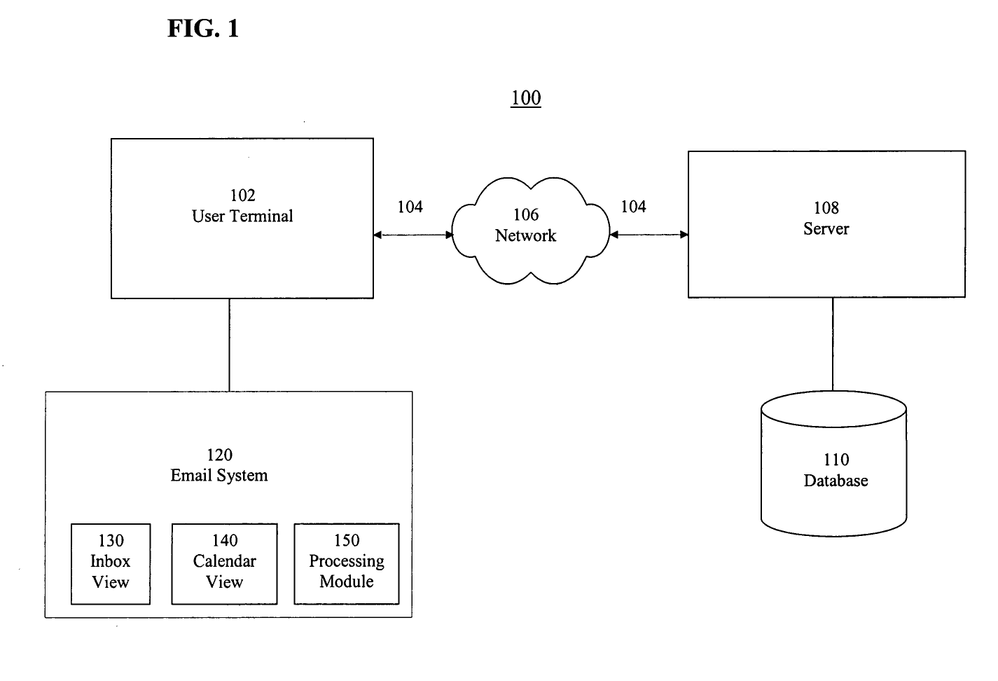

FIG. 1 illustrates a system 100 useful for scrolling to documents having a particular date. As illustrated, a processing module 150 controls various aspects of this invention as will become apparent. In some embodiments of this invention, processing module 150 utilizes a calendar view 140 to scroll documents listed in an inbox view 130 to a particular date.

As illustrated on FIG. 1, processing module 150 operated on or in conjunction with an email system 120 located on a user terminal 102. Although various aspects of the invention are described as implemented using processing module 150 on user terminal 102, it shall be understood by those skilled in the art that processing module 150 may be located on a 108 server or any machine or machines associated with user terminal 102.

While the invention is described as providing a user the ability to more easily scroll to email messages having a particular date, it shall be understood by those skilled in the art that various aspects of the invention may be utilized to more easily scroll any documents within various types of document lists to a particular date. For example, these documents may include events in a calendaring system, documents in a word processing system, or other documents in some other document management system.

User terminal 102 may be connected to server 108 over a network 106 via a communications link 104. Examples of user terminal 102 may include any one or more of, for instance, a desktop computer, a laptop or other portable computer, a hand-held computer device such as a Blackberry, a Personal Digital Assistant (PDA), a web-enabled mobile phone, or a Palm Pilot, or any other computer device.

Network 106 may include any one or more networks. For instance, network 106 may include the Internet, an intranet, a PAN (Personal Area Network), a LAN (Local Area Network), a WAN (Wide Area Network), a SAN (Storage Area Network), a MAN (Metropolitan Area Network), or other network.

Communications link 104 may include any one or more communications links. For instance, communications link 104 may include a copper telephone line, a Digital Subscriber Line (DSL) connection, a Digital Data Service (DDS) connection, an Ethernet connection, an Integrated Services Digital Network (ISDN) line, an analog modem connection, a cable modem connection, a wireless connection, or other communications link.

Server 108 may be or include, for instance, a workstation running Microsoft Windows™ NT™, Microsoft Windows™ 2000, Unix, Linux, Xenix, IBM, AIX™, Hewlett-Packard UX™, Novell Netware™, Sun Microsystems Solaris™, OS/2™, BeOS™, Mach, Apache, OpenStep™, or other operating system or platform.

As illustrated in FIG. 1, a database 110 may be operatively coupled to a server 108. Database 110 may store any information or data required for system 100. Although database 112 is shown as operatively coupled to server 108, database 112 may be located on user terminal 102 or any machine or machines associated with user terminal 102 as would be apparent. Database 112 may store any type of data or information as would be apparent. Database 112 may include, or interface to, for example, the Oracle™ relational database sold commercially by Oracle Corporation, Informix™, DB2 (Database 2) or other data storage or query formats, platforms, or resources such as OLAP (On Line Analytical Processing), SQL (Standard Language Query), a SAN (storage area network), Microsoft Access™ or any other type of database.

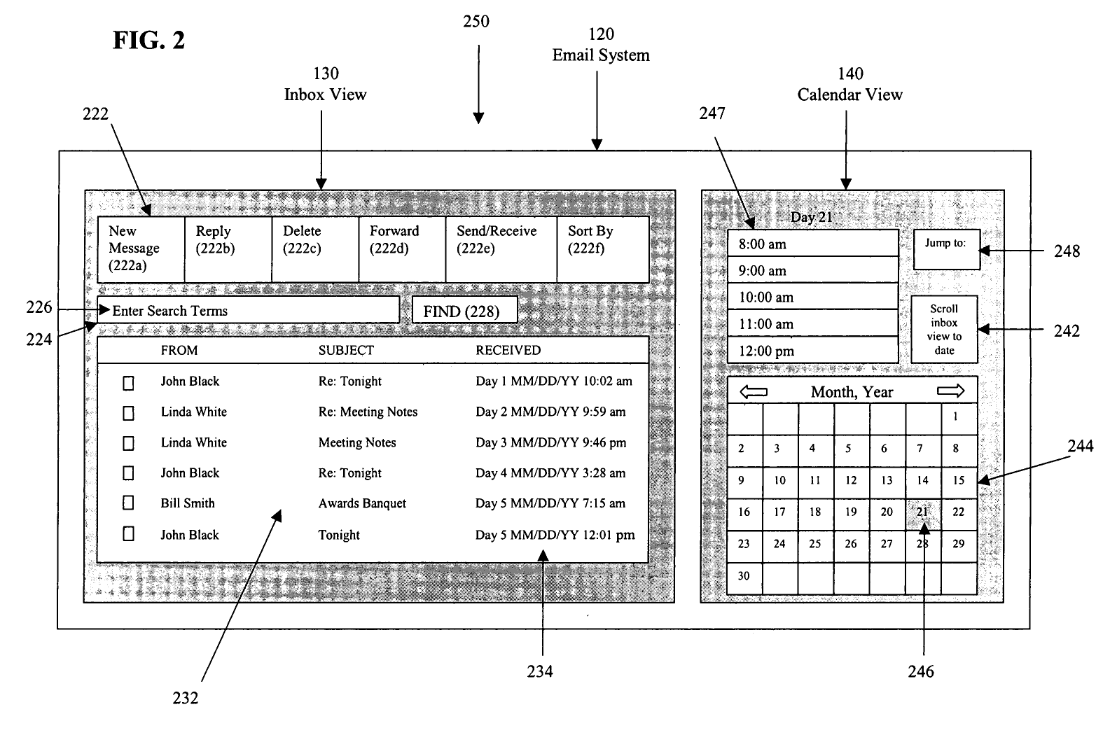

FIG. 2 illustrates both an inbox view 130 and a calendar view 140 of an email system 120. In some embodiments of the invention, processing module 150 utilizes calendar view 140 to scroll email messages listed in inbox view 130 to a particular date.

Inbox view 130 includes a menu 222 which allows a user to manage email system 120. Menu 222 may include one or more items related to various email features known in the art such as “New Message” 222a, “Reply” 222b, “Delete” 222c, “Forward” 222d, “Send/Receive” 222e, “Sort By” 222f, and may include other desired email feature for email system 120. Inbox view 130 may also include a query box 224 that enables a user to perform a search of email messages included in or managed by email system 120. To perform a search, a user may enter search terms 226 in query box 224, and select a “Find” command 228. Inbox view 130 may include these and other email features.

Further, inbox view 130 may also include a message set 232 that includes new and/or saved email messages for a user. Each message of message set 232 may include a selection box that allows a user to select one or more messages and therefore perform an action associated with that message, such as reply, forward, or delete. Although the messages of message set 232 are illustrated with selection boxes, it is understood by those skilled in the art that messages may selected in various ways, such as highlighting the selected message or any other mechanism that selects the desired message.

Email messages of message set 232 include date and time information 234 that corresponds to when the messages were received by email system 120. A user may sort messages of message set 232 by date and time information 234 via menu item “Sort By” 222f. The messages may be sorted in ascending chronological order or descending chronological order, whichever is preferred by the user. Messages may also be sorted according to other criteria via menu item “Sort By” 222f, such as by author, subject, urgency, or any other characteristic by which the user wishes to sort messages of message set 232.

Calendar view 140 is also illustrated in FIG. 2. In some embodiments of the invention, email system 230 may present calendar view 140 and inbox view 130 together in a graphical user interface 250. Calendar view 140 includes an on-screen calendar 244 illustrating days of a particular month. When the user selects a particular date 246, calendar view 140 shows details 247 for that particular date 246. For example, as illustrated in FIG. 2, a particular date 246 corresponding to the 21^{st} of the month is highlighted on on-screen calendar 244. Accordingly, calendar view 140 includes details 247 for this date.

A user may to select particular date 246 in a variety of ways. For example, the user may use arrows provided on on-screen calendar 244 to scroll to previous or following months. Once a desired match is located, a user can select particular date 246 by highlighting the date on calendar 244, as illustrated on FIG. 2.

In some embodiments of the invention, calendar view 140 includes a “Jump to” command 248. A user can enter particular date 246 into “Jump to” command 248, and calendar 244 automatically displays the corresponding month with particular date 246 highlighted on calendar 244. The user may enter the date in various formats, such as, for example, “Dec. 31, 2003” or “12/31/2003.” In addition, calendar view 140 also illustrates the details for particular date 246 which was entered into the “Jump to” command 248, as described above.

Once the user has selected particular date 246, by any of the selection methods described above, the user may also select the “Scroll Inbox View to Date” command 242. “Scroll Inbox View to Date” command 242 allows a user to scroll message set 232 of inbox view 130 to email messages corresponding to particular date 246. In some embodiments, “Scroll Inbox View to Date” command 242 may only be utilized when particular date 246 is the present date or a date in the past because messages with future dates typically do not yet exist. However, some embodiments may include documents with future dates. In these embodiments, a “Scroll Inbox View to Date” may be utilized with future dates as would be apparent. “Scroll Inbox View to Date” command 242 results in messages with date and time information 234 corresponding to particular date 244 being displayed in inbox view 130.

In some embodiments of the invention, the messages of message set 232 may include text within the message itself that corresponds to date and/or time information. Commonly owned co-pending U.S. patent application entitled “Method and Apparatus for Managing Documents with Dates and Times,” Attorney Docket No. 23452-523, filed herewith and incorporated by reference in its entirety, discloses a system that may be incorporated into the invention. These messages may also appear in inbox view 130 for particular date 246.

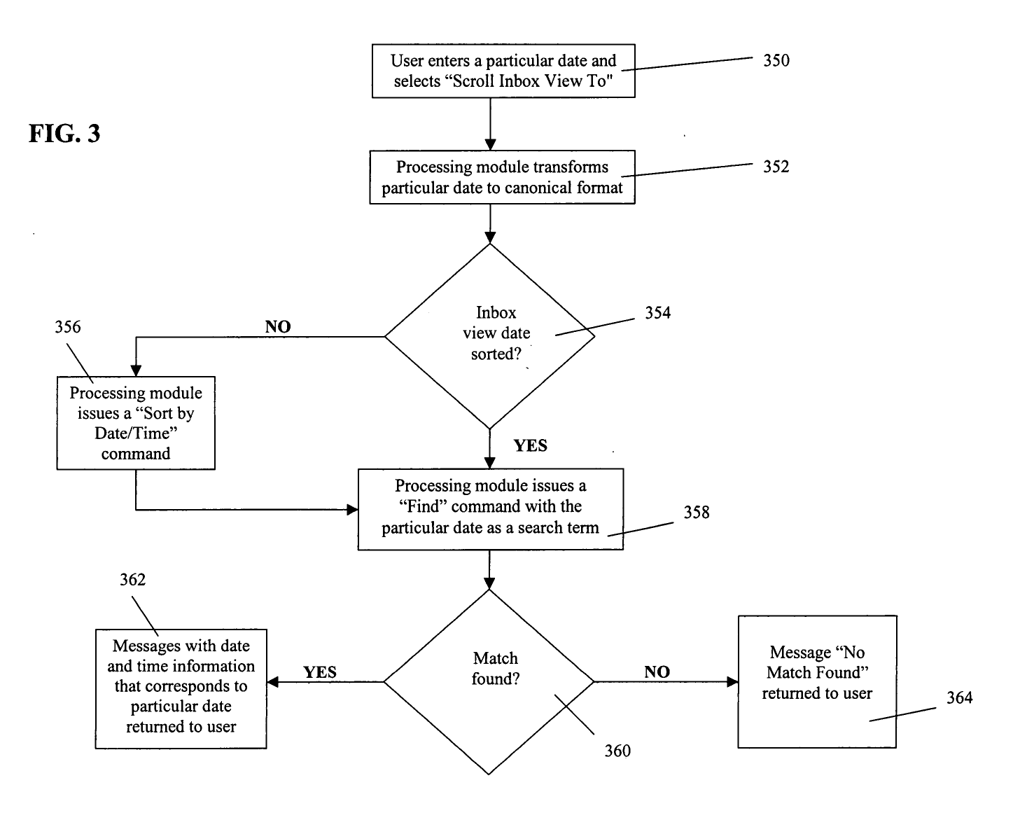

FIG. 3 illustrates a process 300 performed by processing module 1350 when the user chooses the “Scroll Inbox View to Date” command 242 according to various embodiments of the invention. In an operation 350, the user enters a particular date and selects the “Scroll Inbox View to Date” command 242. In some embodiments of the invention, in an operation 352, processing module 150 transforms particular date 246 to a canonically formatted date. In some embodiments of the invention, the canonically formatted date corresponds to the format of dates and/or times used internally by, for example, email system 120, to store and/or process this type of information.

In an operation 354, processing module 150 determines if messages in message set 232 of inbox view 130 are sorted according to date and time information 234. As previously discussed, a user can sort messages of message set 232 by date and time information 234 via menu item “Sort By” 222f. The messages may be sorted in ascending chronological order or descending chronological order, whichever is preferred by the user. If processing module 150 determines that messages in message set 232 of inbox view 130 are not sorted according to date and time information 234, processing module automatically issues a sort command via menu item “Sort By” 222f in operation 356.

After messages in message set 232 of inbox view 130 are sorted according to date and time information 234, in operation 358 processing module 150 issues a “Find” command 228 (or its equivalent as would be apparent). Processing module 150 uses the canonically formatted date as search terms 226 in query box 224. Email system 120 accordingly identifies these messages in message set 232 with date and time information 234 that corresponds to particular date 246.

In an operation 360, processing module 150 determines if any messages in message set 232 include date and time information 234 that corresponds to particular date 246. If there are no messages with date and time information 234 that correspond to particular date 246, processing module 150 returns an indication, such as, “No Match Found” to the user in operation 364.

If there are messages with date and time information 234 that correspond to particular date 246, processing module 150 scrolls message set 232 such that the first message with a date matching particular date 246 is displayed and selected in message set 232. All messages with date and time information 234 that correspond to particular date 246 are accordingly displayed to the user.

While particular embodiments of the present invention have been described, it is to be understood that modifications will be apparent to those skilled in the art without departing from the spirit of the invention. The scope of the invention is not limited to the specific embodiments described herein. Other embodiments, uses and advantages of the invention will be apparent to those skilled in art from consideration of the specification and practice of the invention disclosed herein. The specification should be considered exemplary only, and the scope of the invention is accordingly intended to be limited by the following claims.

1. A method for scrolling among a list of items, each of the items associated with at least a date, the method comprising:
in response to a user entering a date, converting the entered date to a canonically formatted date;
sorting the list of items by at least date; and
scrolling the list of items to those items having a date corresponding to the canonically formatted date.

2. The method of claim 1, wherein said sorting the list of items comprises sorting the list of items in response to the user issuing a sort command.

3. The method of claim 1, wherein said sorting the list of items comprises automatically sorting the list of items after the user enters the date.

4. The method of claim 1, wherein said scrolling the list of items to those items having a date corresponding to the canonically formatted date comprises automatically searching for those items having a date corresponding to the canonically formatted date.

5. The method of claim 4, wherein said automatically searching for those items having a date corresponding to the canonically formatted date comprises automatically issuing a find command with the canonically formatted date.

6. The method of claim 1, further comprising providing a calendar view to the user, the calendar view having a plurality of selectable days by which the user enters the date.

7. The method of claim 1, further comprising providing a date entry field to the user by which the user enters the date.

8. The method of claim 7, wherein the date entry field allows the user to enter the date in a variety of formats.

9. A method for scrolling among a message set including a plurality of messages, each of the messages associated with at least a date, the method comprising:
in response to a user entering a date, converting the entered date to a canonically formatted date;
sorting the message set by at least date; and
presenting those messages of the message set having a date corresponding to the canonically formatted date.

10. The method of claim 9, wherein said sorting the message set comprises automatically sorting the message set after the user enters the date.

11. The method of claim 9, wherein said presenting those messages of the message set having a date corresponding to the canonically formatted date comprises automatically retrieving those messages having a date corresponding to the canonically formatted date.

12. The method of claim 11, wherein said automatically retrieving those messages of the message set having a date corresponding to the canonically formatted date comprises automatically issuing a find command with the canonically formatted date.

13. A graphical user interface comprising:
a calendar view through which date information is received from a user; and
a list view for presenting a plurality of non-calendar items to a user, each of the plurality of non-calendar items associated with a date, the list view updated each time date information is received from the user with those non-calendar items having a date corresponding to the date information.

14. The graphical user interface of claim 13, wherein the calendar view comprises a plurality of selectable days by which the user enters date information.

15. The graphical user interface of claim 13, wherein the list view presents a plurality of messages.

16. The graphical user interface of claim 13, wherein the list view presents a plurality of email messages.

17. The graphical user interface of claim 13, wherein the list view corresponds to an inbox of an email system.
